(19) United States
(12) Patent Application Publication
(10) Pub. No.: US 2009/0109799 A1
(43) Pub. Date: Apr. 30, 2009

(54) SYSTEM AND METHOD FOR DISPLAYING A CALENDAR FOR BROWSING DIGITAL IMAGES

(75) Inventor: Ta-Wei Wang, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/206,734

(22) Filed: Sep. 9, 2008

(30) Foreign Application Priority Data
Oct. 31, 2007 (CN) 200710202338.5

(51) Int. Cl. G04C 17/00; G04B 47/00

(52) U.S. Cl. 368/10; 368/29

(57) ABSTRACT

A method for displaying a calendar for browsing digital images is disclosed. The method includes generating data for each of a plurality of digital image files captured by the camera module, wherein the data are stored in an image file list. A selected calendar month of the calendar is read and a date of a day in the calendar month is read. The read date listed in the image file list in the calendar is highlighted. The highlighted calendar of the calendar month is displayed. A related system is also provided.

### BACKGROUND OF THE INVENTION

1. Field of the Invention

Embodiments of the present disclosure relate digital images, and particularly to a system and method for displaying a calendar for browsing digital images.

2. Description of Related Art

Currently, there are a number of digital capture devices including, but not limited to, mobile phones, cameras with the function of displaying calendar. The function is convenient for users to setup time, write comments on special days, and so on.

However, if a user wants to view a digital image and further wants to know what day the digital image was captured on, the digital device has to invoke the digital image album interface. Then the user searches the digital image in the digital image album and gets the date through viewing the information of the digital image. It is very cumbersome for the user to operate and much time will be wasted.

Therefore, what is needed is a more convenient system and method for browsing a digital image album on an electronic device.

### SUMMARY

A system, having a camera module, for displaying a calendar for browsing digital images is provided. The system includes: a data generating modules, a executing module, a detecting module, a setting module, and a displaying module. The data generating module is configured for generating data for each of a plurality of digital image files captured by the camera module, wherein the data are stored in an image file list in a memory system of the system. The executing module is configured for reading a selected calendar month of the calendar, and reading a date of a day in the calendar month. The detecting module is configured for determining if the read date is listed in the image file list. The setting module is configured for highlighting the date listed in the image file list in the calendar. The displaying module is configured for displaying the highlighted calendar of the calendar month.

Other objects, advantages and novel features of the embodiments will be drawn from the following detailed description together with the attached drawings.

### BRIEF DESCRIPTION OF THE DRAWINGS

FIG. 1 is a block diagram of one embodiment of a system for displaying a calendar for browsing digital images.

FIG. 2 is a block diagram of one embodiment of the software program comprising function modules.

FIG. 3 is a flowchart of one embodiment of a method for generating a calendar for browsing digital images.

FIG. 4 is a flowchart of one embodiment of a method for browsing the digital images based on the calendar.

FIG. 5 shows one embodiment of an image file list.

FIG. 6A and FIG. 6B respectively shows one embodiment of one kind of a file directory.

FIG. 7 shows one embodiment of a calendar without any highlights.

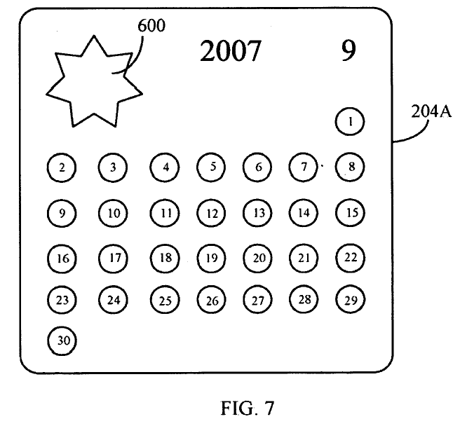

FIG. 8 shows one embodiment of a highlighted calendar.

### DETAILED DESCRIPTION

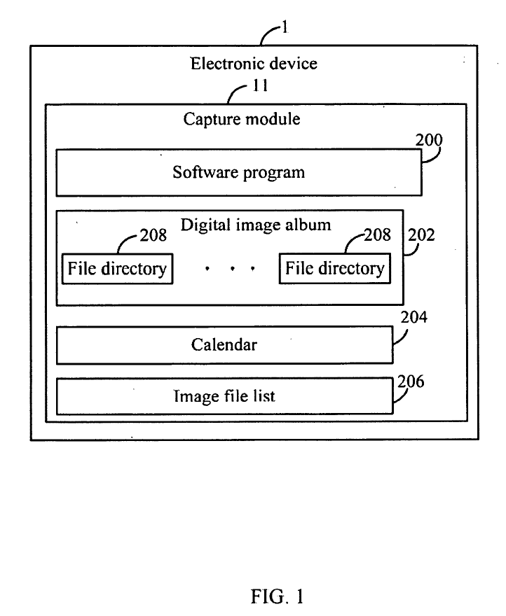

FIG. 1 is a block diagram of one embodiment of a system 1 for displaying a calendar for browsing digital images. The system 1 may be an electronic device 1 that may include, but is not limited to, a mobile phone or a camera having a camera module 11. The camera module 11 is used for capturing digital images. The camera module 11 includes a software program 200, a digital image album 202, a calendar 204, and an image file list 206. The digital image album 202 includes a file directory structure that is configured with one or more file directories 208. Each directory 208 stores one or more digital image files captured on a same day.

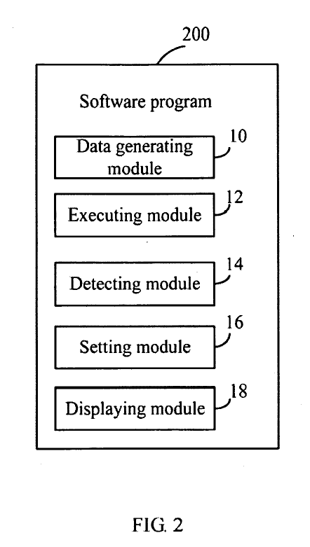

FIG. 2 is a block diagram of one embodiment of the software program 200 comprising function modules. In one embodiment, the software program 200 may include a data generating module 10, an executing module 12, a detecting module 14, a setting module 16, and a displaying module 18. The software function modules may be used to implement certain functions of the system 1. It may be understood that one or more specialized or general purpose processors (not shown) may be used to execute the software function modules 10, 12, 14, 16, 18.

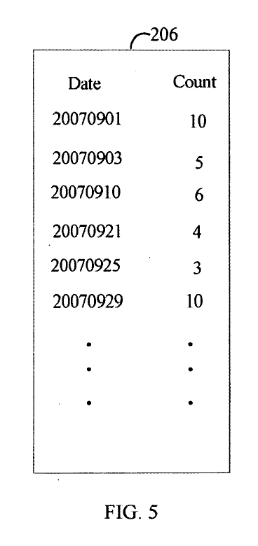

The data generating module 10 is configured for generating data for each of the digital image files captured by the camera module 11 in the image file list 206. Referring to FIG. 5, the data in the image file list 206 may include two columns, such as a date column and a count column. Each entry in the image file list 206 lists how many images were taken on a selected date. For example, the image file list 206 shows that 10 images that were taken on Sep. 1, 2007. Depending on the embodiment, the image file list 206 may be stored in a memory system of the system 1, such as in random access memory, read only memory, a hard disk drive, flash memory, or an external card system, for example.

The executing module 12 is configured for reading a selected calendar month of the calendar 204 and displaying the selected calendar month on a display (not shown) of the system 1. The executing module 12 is also configured for reading the date of a day in the calendar month. In one embodiment, the executing module 12 reads the date from the first day to the last day in the calendar month.

The detecting module 14 is configured for determining if the date is listed in the image file list 206.

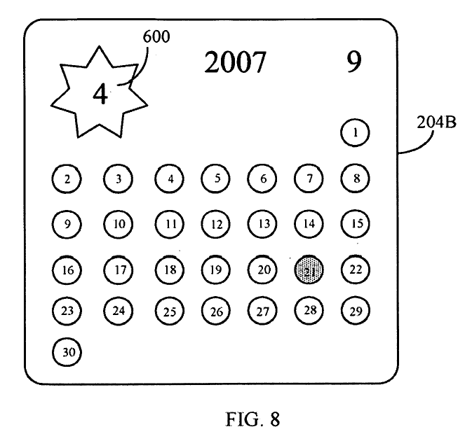

The setting module 16 is configured for highlighting the date listed in the image file list 206 in the calendar 204. In one embodiment, the date can be highlighted by changing a background color of the date in the calendar 204 or by changing a color of the figure of the date. Referring to FIG. 8, a methods for highlighting a date in the calendar 204 is shown. Each date is shown in a circle. For example, September. 21 is not listed in the image file list 206, so the highlighting module 18 highlights the date of September. 21 by changing the background color in the calendar 204B.

The detecting module 14 is also configured for determining if the date is the last day of the calendar month if the date is not listed in the image file list 206.

The executing module 12 is further configured for obtaining the next date of the day, if the date is not the last day of the calendar month.

The displaying module 18 is configured for displaying the calendar 204. If there are no digital images captured on the calendar month, the displaying module 18 displays a calendar 204A without any highlights. Otherwise, if there are one or more digital images captured on a selected calendar month, the displaying module 18 displays a highlighted calendar 204B.

The detecting module 14 is further configured for determining if a date selected by a user is listed in the image file list 206.

The displaying module 18 is also configured for displaying a number of digital images captured on the selected date, if the selected date is in the image file list 206. Referring to the FIG. 8, if four digital images are captured on Sep. 21, 2007, the displaying module 18 displays a number “4” on the blank 600.

The executing module 12 is also configured for reading a file directory 208 corresponding to the selected date. Each file directory 208 includes information of all digital images captured on the selected date. The information includes digital images, names of the digital images and so on.

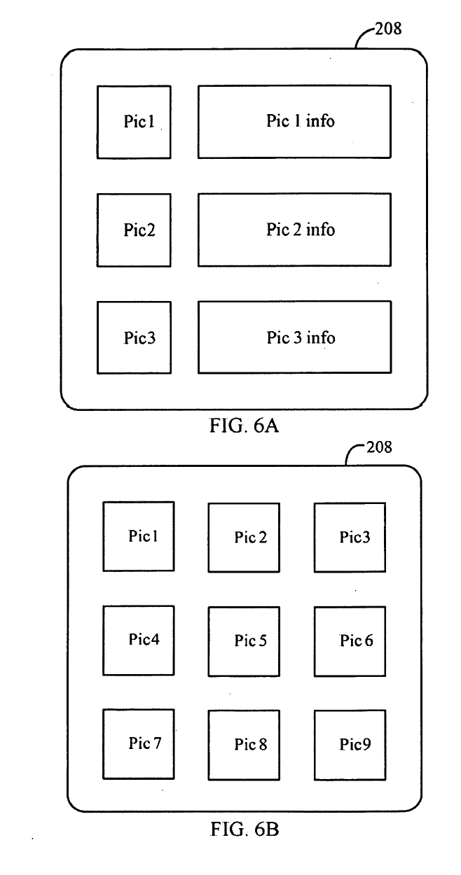

The displaying module 18 is further configured for displaying the information of the digital images captured on the selected date. Referring to FIG. 6A and FIG. 6B, there are two types of the interfaces of the file directory 208.

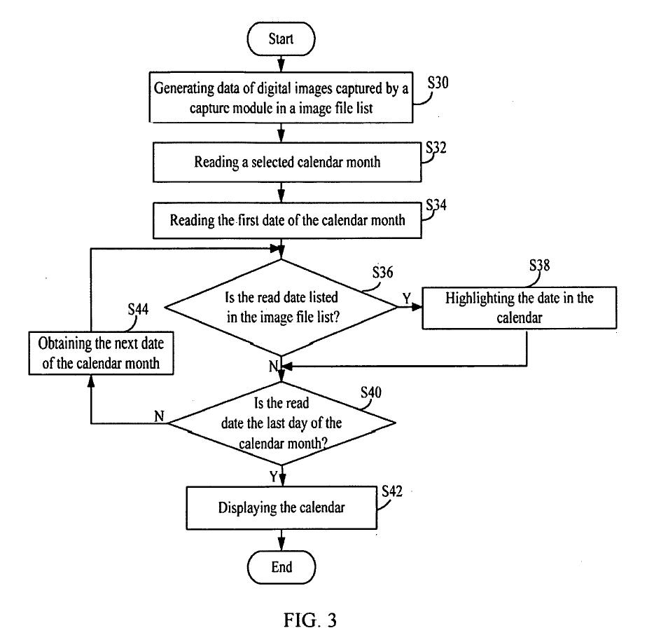

FIG. 3 is a flowchart of one embodiment of a method for generating a calendar for browsing digital images. Depending on the embodiment, additional blocks may be added, others removed, and the ordering of the blocks may be changed. In block S30, the data generating module 10 generates data for each of the digital image files captured by the camera module 11 in the image file list 206.

In block S32, the executing module 12 reads a selected calendar month of the calendar 204 and displays the selected calendar month on the display of the system 1.

In block S34, the reading module 12 reads the first date of the calendar month.

In block S36, the detecting module 14 detects if the read date is listed in the image file list 206.

In block S38, the setting module 16 highlights each day in the calendar month that is listed in the image file list 206.

If the read date is not listed in the image file list 206, in block S40, the detecting module 14 detects if the read date is the last day of the calendar month.

If the read date is the last day of the calendar month, in block S42, the displaying module 18 displays the calendar 204 of the calendar month. If there are no images captured on the calendar month, the displaying module 18 displays the calendar 204A having no highlighted dates. Otherwise, if there are images captured on the calendar month, the displaying module 18 displays the calendar 204B having one or more highlighted dates.

If the read date is not the last day of the calendar month, in block S44, the executing module 12 obtains the next date of the read date if the read date is not the last day of the calendar month and the procedure returns to the block S36.

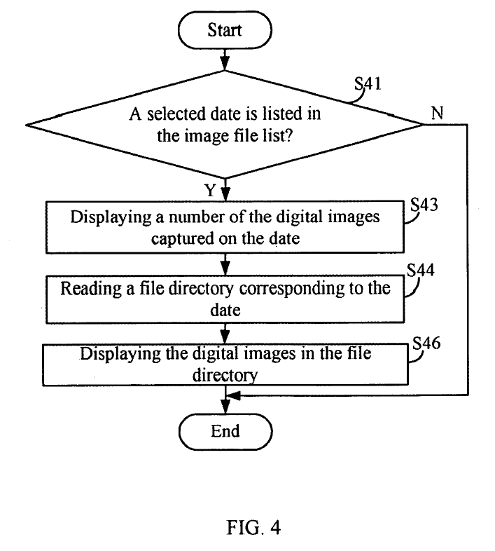

FIG. 4 is a flowchart of one embodiment of a method for browsing the digital images based on the calendar. In block S41, the detecting module 14 determines if the selected date is listed in the image file list 206. If the selected date is not listed in the image file list 206, the procedure ends.

If the selected date is listed in the image file list 206, in block S43, the displaying module 18 displays a total number of digital images captured on the selected date.

In block S45, the executing module 12 reads a file directory 208 corresponding to the selected date.

In block S47, the displaying module 18 displays the information of the digital images captured on the date.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system, having a camera module, for displaying a calendar for browsing digital images, the system comprising:
a data generating module configured for generating data for each of a plurality of digital image files captured by the camera module, wherein the data are stored in an image file list in a memory system of the system;
an executing module configured for reading a selected calendar month of the calendar, and reading a date of a day in the calendar month;
a detecting module configured for determining if the read date is listed in the image file list;
a setting module configured for highlighting the date listed in the image file list in the calendar; and
a displaying module configured for displaying the highlighted calendar of the calendar month.

2. The system according to claim 1, wherein the image file list comprises a date column and a count column.

3. The system according to claim 1, wherein the detecting module is further configured for determining if a selected date is listed in the image file list.

4. The system according to claim 1, wherein the displaying module is further configured for displaying the total number of digital images captured on the selected date if the selected date is listed in the image file list;
the executing module is further configured for reading a file directory corresponding to the selected date; and
the displaying module is further configured for displaying information of the digital images captured on the selected date.

5. The system according to claim 1, wherein the memory system is selected from the group consisting of a random access memory, a read only memory, a hard disk drive, a flash memory, and an external card system.

6. A method for displaying a calendar for browsing digital images in a electronic device comprising a camera module, the method comprising:
generating data for each of a plurality of digital image files captured by the camera module, wherein the data are stored in an image file list in a memory system of the electronic device;
reading a selected calendar month of a calendar in the camera module;
reading a date of a day in the calendar month;
determining if the read date is listed in the image file list;
highlighting the read date listed in the image file list in the calendar; and
displaying the highlighted calendar of the calendar month.

7. The method according to claim 6, wherein the image file list comprises a date column and a count column.

8. The method according to claim 6, further comprising:
determining if a selected date is listed in the image file list;
displaying a total number of digital images captured on the selected date if the selected date is listed in the image file list;
reading a file directory corresponding to the selected date; and
displaying information of the digital images captured on the selected date.

9. The system according to claim 6, wherein the memory system is selected from the group consisting of a random access memory, a read only memory, a hard disk drive, a flash memory, and an external card system.

10. A medium having stored instructions for displaying a calendar for browsing digital images, the medium, when executed by a camera module in a electronic device, causes the camera module to:
generating data for each of a plurality of digital image files captured by the camera module, wherein the data are stored in an image file list in a memory system of the electronic device;
reading a selected calendar month of the calendar;
reading a date of a day in the calendar month;
determining if the read date is listed in the image file list;
highlighting the date listed in the image file list in the calendar; and
displaying the highlighted calendar of the calendar month.

11. The system according to claim 10, wherein the memory system is selected from the group consisting of a random access memory, a read only memory, a hard disk drive, a flash memory, and an external card system.
